(19) United States
(12) Patent Application Publication
(10) Pub. No.: US 2025/0068320 A1
(43) Pub. Date: Feb. 27, 2025

(54) Display apparatus having an on-screen display control mechanism and on-screen display control method of the same

(71) Applicant: REALTEK SEMICONDUCTOR CORPORATION, Hsinchu (TW)

(72) Inventors: Tsung-Hsien LEE, Hsinchu (TW); Shih-Cheng TSAI, Hsinchu (TW)

(21) Appl. No.: 18/805,588

(22) Filed: Aug. 15, 2024

(30) Foreign Application Priority Data
Aug. 21, 2023 (TW) 112131406

(51) Int. Cl. G06F 3/04847; G06F 3/02

(52) U.S. Cl. CPC G06F 3/04847; G06F 3/02

(57) ABSTRACT

The present disclosure discloses a display apparatus having an on-screen display control mechanism. A signal receiving terminal receives a keyboard input signal. A signal transmission circuit receives the keyboard input signal by using an input terminal from the signal receiving terminal and transmits the keyboard input signal to a first output terminal and a second output terminal respectively in a keyboard signal transmission mode and a on-screen display control mode. The display control circuit controls a display panel to display a on-screen display including control items and an indicating object under the on-screen display control mode, receive the keyboard input signal from the second output terminal to retrieve key information and control the indicating object according to the key information to move among the control items to switch a selected control item indicated thereby or execute a control function of the selected control item.

### BACKGROUND OF THE INVENTION

### 1. Field of the Invention

The present disclosure relates to a display apparatus having an on-screen display control mechanism and an on-screen display control method of the same.

### 2. Description of Related Art

Display apparatuses not only display a frame according to display data, but also display an on-screen display (OSD) frame to allow users to adjust the display parameters, such as but not limited to brightness, contrast and size of the display apparatuses.

A common method to operate the on-screen display frame is to dispose physical buttons on the display apparatuses. However, the operation of the physical buttons is not intuitive. Further, some display apparatuses dispose the physical buttons on the rear end thereof such that the users have difficulty to touch the correct button. Such disposition makes the user unable to fluently adjust the display parameters of the display apparatuses.

### SUMMARY OF THE INVENTION

In consideration of the problem of the prior art, an object of the present disclosure is to provide a display apparatus having an on-screen display control mechanism and an on-screen display control method of the same.

The present invention discloses a display apparatus having an on-screen display control mechanism that includes a signal receiving terminal, a signal transmission circuit, a display panel and a display control circuit. The signal receiving terminal is configured to receive a keyboard input signal corresponding to a keyboard. The signal transmission circuit is configured to receive the keyboard input signal through an input terminal from the signal receiving terminal, transmit the keyboard input signal to a first output terminal under a keyboard signal transmission mode and transmit the keyboard input signal to a second output terminal under an on-screen display control mode. The display control circuit is electrically coupled to the signal transmission circuit and the display panel and is configured to: control the display panel to display an on-screen display frame comprising a plurality of control items and an indicating object under the on-screen display control mode, wherein one of the control items indicated by the indicating object is selected to be a selected control item, receive the keyboard input signal from the second output terminal to retrieve key information of the keyboard input signal and control the indicating object to move among the control items to switch the selected control item indicated thereby or execute a control function of the selected control item according to the key information.

The present invention also discloses an on-screen display control method used in a display apparatus that includes steps outlined below. A keyboard input signal corresponding to a keyboard is received by a signal receiving terminal. The keyboard input signal is received through an input terminal from the signal receiving terminal, the keyboard input signal is transmitted to a first output terminal under a keyboard signal transmission mode and the keyboard input signal is transmitted to a second output terminal under an on-screen display control mode by a signal transmission circuit. The display panel is controlled to display an on-screen display frame comprising a plurality of control items and an indicating object under the on-screen display control mode by a display control circuit, wherein one of the control items indicated by the indicating object is selected to be a selected control item. The keyboard input signal is received from the second output terminal to retrieve key information of the keyboard input signal by the display control circuit. The indicating object is controlled to move among the control items to switch the selected control item indicated thereby or execute a control function of the selected control item according to the key information by the display control circuit.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a circuit diagram of a display apparatus having an on-screen display control mechanism according to an embodiment of the present invention.

FIG. 2A to FIG. 2D illustrate diagrams of the on-screen display frame displayed by the display panel according to an embodiment of the present invention.

FIG. 3 illustrates a flow chart of an on-screen display control method according to an embodiment of the present invention.

### DETAILED DESCRIPTION OF THE PREFERRED EMBODIMENTS

An aspect of the present invention is to provide a display apparatus having an on-screen display control mechanism and an on-screen display control method of the same to dispose a signal transmission circuit such that a keyboard input signal not only can be transmitted to a computer host terminal, but also to be used to intuitively adjust the on-screen display without the need to identify the location information.

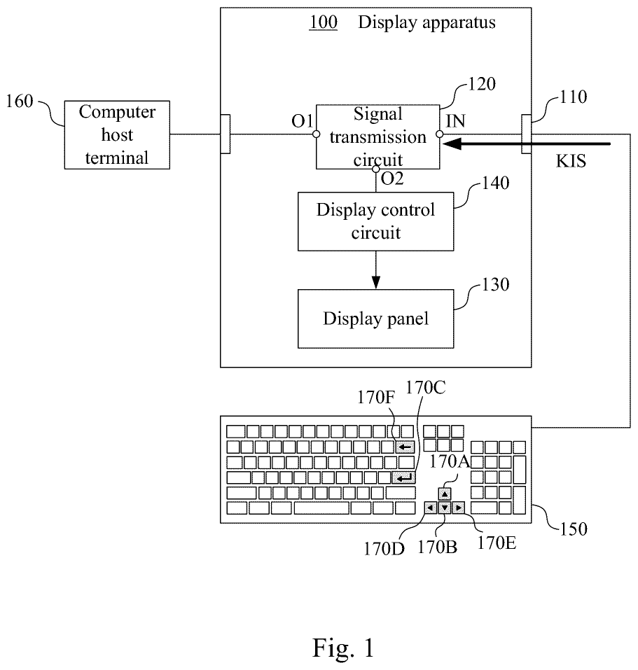

Reference is now made to FIG. 1. FIG. 1 illustrates a circuit diagram of a display apparatus 100 having an on-screen display control mechanism according to an embodiment of the present invention. The display apparatus 100 includes a signal receiving terminal 110, a signal transmission circuit 120, a display panel 130 and a display control circuit 140.

The signal receiving terminal 110 is configured to receive a keyboard input signal KIS. In an embodiment, the signal receiving terminal 110 is such as, but not limited to universal serial bus (USB) connection interface to be electrically coupled to a keyboard 150 external to the display apparatus 100 and receive the keyboard input signal KIS from the keyboard 150. The keyboard 150 includes a plurality of keypads.

The signal transmission circuit 120 includes an input terminal IN, a first output terminal O1 and a second output terminal O2. The signal transmission circuit 120 can be such as, but not limited to a hub of universal serial bus transmission interface and is configured to receive the keyboard input signal KIS through the input terminal IN from the signal receiving terminal 110. According to different operation modes, the signal transmission circuit 120 transmits the keyboard input signal KIS to at least one of the first output terminal O1 and the second output terminal O2.

Under the keyboard signal transmission mode, the signal transmission circuit 120 transmits the keyboard input signal KIS to the first output terminal O1. In an embodiment, the first output terminal O1 is electrically coupled to a computer host terminal 160. In an embodiment, the first output terminal O1 of the display apparatus 100 is electrically coupled to the computer host terminal 160 through such as, but not limited to a path having the format of Type-C universal serial bus to accomplish bi-direction transmission.

As a result, by using the path between the first output terminal O1 and the computer host terminal 160, the computer host terminal 160 transmits display data (not illustrated) to the display apparatus 100. The display data is further transmitted to the display control circuit 140 through such as the path (not illustrated in the figure) between the first output terminal O1 and the display control circuit 140 within the display apparatus 100 to be displayed on the display panel 130.

At the same time, by disposing the signal transmission circuit 120, the display apparatus 100 allows the keyboard input signal KIS to be transmitted to the computer host terminal 160 through the path between the first output terminal O1 and the computer host terminal 160 described above to control the computer host terminal 160.

On the other hand, under the on-screen display control mode, the signal transmission circuit 120 transmits the keyboard input signal KIS to the second output terminal O2. In an embodiment, the second output terminal O2 is electrically coupled to the display control circuit 140.

The display control circuit 140 is electrically coupled to the signal transmission circuit 120 and the display panel 130. The display control circuit 140 is configured to, under the on-screen display control mode, control the display panel 130 to display an on-screen display frame that includes a plurality of control items and an indicating object, wherein one of the control items indicated by the indicating object is selected to be a selected control item.

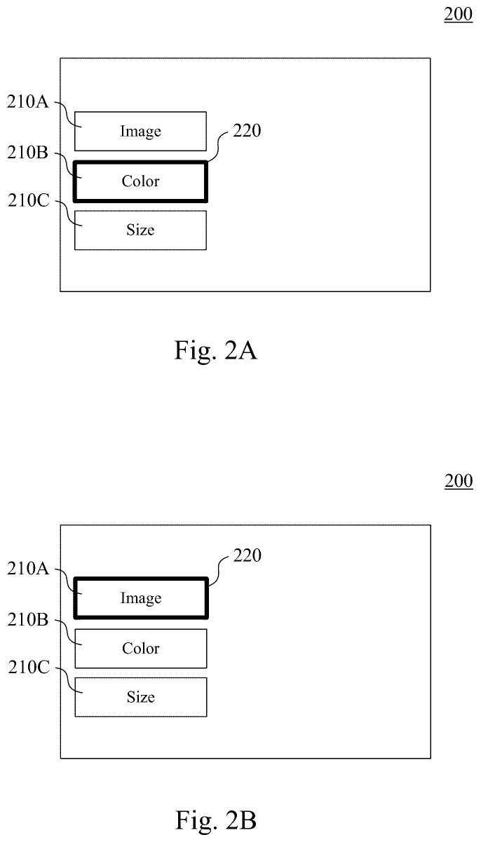

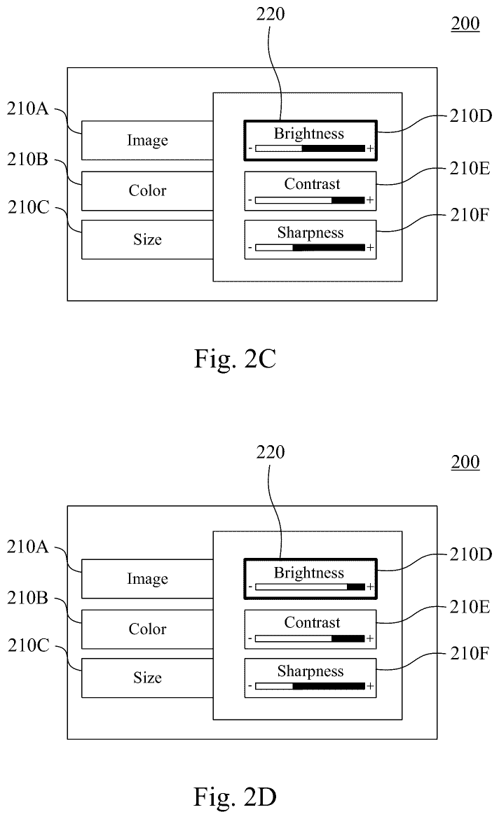

Reference is now made to FIG. 2A to FIG. 2D. FIG. 2A to FIG. 2D illustrate diagrams of the on-screen display frame 200 displayed by the display panel 130 according to an embodiment of the present invention.

As illustrated in FIG. 2A, the on-screen display frame 200 includes a plurality of control items 210A-210C and an indicating object 220. The control items 210A-210C are such as, but not limited to items of a menu, in which these items correspond to image parameters, color parameters and size parameters.

The indicating object 220 is an indicating thick frame enclosing the control item 210B in FIG. 2A, in which the control item 210B indicated thereby is selected to be the selected control item. In other embodiments, the indicating object 220 can be a color layer or a glowing layer covering the control item, or can be any other objects displayed to select the control item. The present invention is not limited thereto.

The display control circuit 140 is configured to receive the keyboard input signal KIS from the second output terminal O2 to retrieve the key information (not illustrated in the figure) of the keyboard input signal KIS.

In an embodiment, the keyboard input signal KIS includes human interface device (HID) descriptor information. The display control circuit 140 is configured to retrieve the key information related to the keyboard 150 from the human interface device descriptor information, in which the key information are information corresponding to the physical keypads being triggered on the keyboard 150.

In an embodiment, the signal transmission circuit 120 is configured to perform format conversion on the human interface device descriptor information such that the format thereof is converted to such as, but not limited to I²C. The display control circuit 140 retrieves the key information from the human interface device descriptor information having the format converted.

The display control circuit 140 identifies the key information to be direction information or operation information according to an internal firmware (not illustrated in the figure).

The display control circuit 140 moves the indicating object 220 among the control items to switch the selected control item indicated thereby when the key information is identified to be the direction information.

For example, under the condition illustrated in FIG. 2A, the display control circuit 140 may identify the key information generated by a keypad 170A of a direction “UP” and a keypad of a direction “DOWN” included by the keyboard 150 in FIG. 1 to be the direction information. When the key information received by the display control circuit 140 is generated according to the keypad 170A of the direction “UP”, the indicating object 220 is moved to the control item 210A, as illustrated in FIG. 2B, such that the control item 210A indicated thereby is selected to be the selected control item.

The display control circuit 140 executes the control function of the selected control item when the key information is identified to be the operation information. In an embodiment, the control function includes entering a next layer menu to allow the indicating object 220 indicating one of the control items included by the next layer menu, exiting to a pervious layer menu to allow the indicating object 220 indicating one of the control items included by the pervious layer menu, or adjusting a display parameter of the display panel 130 that the selected control item corresponds to.

For example, under the condition illustrated in FIG. 2B, the display control circuit 140 may identify the key information generated according to the keypad 170C of an “ENTER” function included by the keyboard 150 in FIG. 1 to be the operation information, such that the next layer menu corresponding to the control item 210A related to the image parameters is entered as illustrated in FIG. 2C. Under such a condition, the menu of the control item 210A includes control items 210D-210F, in which the control items 210D-210F are such as, but not limited to the display parameter control items of brightness, contrast and sharpness.

When the menu corresponding to the control item 210A is entered, the display control circuit 140 simultaneously allows the indicating object 220 indicating one of the control items, e.g., the control item 210D illustrated in FIG. 2C, included by the menu, such that the control item 210D is selected to be the selected control item.

Under the condition illustrated in FIG. 2C, the display control circuit 140 may identify the key information generated by a keypad 170D of a direction “LEFT” direction and a keypad 170E of a direction “RIGHT” included by the keyboard 150 in FIG. 1 to be the operation information. When the key information received by the display control circuit 140 is generated according to the keypad 170E of the direction “RIGHT”, the brightness parameter that the selected control item (i.e., the control item 210D) corresponds to is adjusted as illustrated in FIG. 2D to increase the brightness of the display panel 130.

Besides, under the condition illustrated in FIG. 2C, the display control circuit 140 may identify the key information generated by a keypad 170F of a “BACKSPACE” function included by the keyboard 150 in FIG. 1 to be the operation information, such that the menu corresponding to the control item 210A is exited to the pervious layer menu as illustrated in FIG. 2B to allow the indicating object 220 indicating one of the control items included by the pervious layer menu, such as but not limited to the control item 210A in FIG. 2B such that the control item 210A is selected to be the selected control item.

As a result, by disposing the signal transmission circuit 120, the display apparatus 100 of the present application serves as a signal transmission relay to transmit the keyboard input signal KIS from the keyboard 150 to the computer host terminal 160 under the keyboard signal transmission mode. Further, the display apparatus 100 can control the on-screen display frame 200 according to the keyboard input signal KIS from the keyboard 150 under the on-screen display control mode to adjust the display parameter of the display panel 130. The keyboard signal transmission and the control of the on-screen display frame 200 without the need to identify location information of the signal input can be both accomplished by the display apparatus 100.

It is appreciated that the correspondence relations between the keypads and the direction information and the operation information described above are merely an example. In other embodiment, corresponding to the arrangement of the control items on the on-screen display frame, the key information generated by the keypad of the “UP” direction and the keypad of the “DOWN” direction included by the keyboard 150 can be identified to be the operation information, and the key information generated by the keypad of the “LEFT” direction and the keypad of the “RIGHT” direction included by the keyboard 150 can be identified to be the direction information. Further, other keypads, e.g., the alphabet keypads, the number keypads and the function keypads, included by the keyboard 150 can also be configured to be corresponding to the direction information and the operation information. The present invention is not limited thereto.

In an embodiment, the keyboard input signal KIS is generated by a plurality of specific keypads or a plurality of non-specific keypads of the keyboard 150. The specific keypads are such as, but not limited to the keypads 170A-170F illustrated as gray blocks in FIG. 1. The non-specific keypads are such as, but not limited to the other keypads illustrated as white blocks in FIG. 1.

The signal transmission circuit 120 is further configured to transmit the keyboard input signal KIS generated according to the non-specific keypads to the first output terminal O1 under both of the keyboard signal transmission mode and the on-screen display control mode.

Under such a condition, the user can still control the computer host terminal 160 that the first output terminal O1 is electrically coupled to by using the non-specific keypads of the keyboard 150 even if the on-screen display control mode is entered, in which the on-screen display frame 200 is controlled by the specific keypads of the keyboard 150. As a result, the display frame that the display panel 130 displays according to the data from the computer host terminal 160 and the on-screen display frame 200 can be operated simultaneously without being affected by each other under the on-screen display control mode.

In an embodiment, the switching of the operation modes (i.e., the keyboard signal transmission mode and the on-screen display control mode) described above is performed according to a composite keypad signal formed by a multiple of the keyboard input signals KIS generated simultaneously by the keyboard 150. These keyboard input signals KIS can be generated by pressing a multiple of keypads of the keyboard 150 simultaneously by the user.

For example, when a function keypad of “SHIFT”, a function keypad of “ALT” and an alphabet keypad “O” included by the keyboard 150 are triggered simultaneously, the three keyboard input signals KIS generated by the three keypads form the composite keypad signal to be used to switch the operation modes. It is appreciated that the combination of the keypads described above is merely an example. In other embodiments, the composite keypad signal can be generated according to different numbers and different combinations of the keypads. The present invention is not limited thereto.

In an embodiment, the signal transmission circuit 120 is further configured to also transmit the keyboard input signal KIS to the second output terminal O2 under the keyboard signal transmission mode such that the display control circuit 140 control the signal transmission circuit 120, according to a composite keypad signal formed by a multiple of the keyboard input signals KIS generated simultaneously by the keyboard 150, to switch to be operated between the keyboard signal transmission mode and the on-screen display control mode. The signal transmission circuit 120 further stops to transmit the keyboard input signal KIS generated by the specific keypads to the first output terminal O1 under the on-screen display control mode.

In another embodiment, the operation of the keyboard signal transmission mode and the on-screen display control mode is determined by the display control circuit 140. For example, the display control circuit 140 monitors the signals representing the triggering of the combination of keypads used to switch the display control from the signal transmission circuit 120. After the composite keypad signal is received, the keyboard input signal KIS is only transmitted to the second output terminal O2 without to the first output terminal O1 according to the keyboard signal transmission mode and the on-screen display control mode to avoid the signal affecting the operation of the programs run on the computer host terminal 160. After the operation of the display control is finished, the signal transmission circuit 120 is controlled to transmit the keyboard input signal KIS simultaneously to the first output terminal O1 and the second output terminal O2. The display control circuit 140 then keeps monitoring the signals representing the triggering of the combination of keypads.

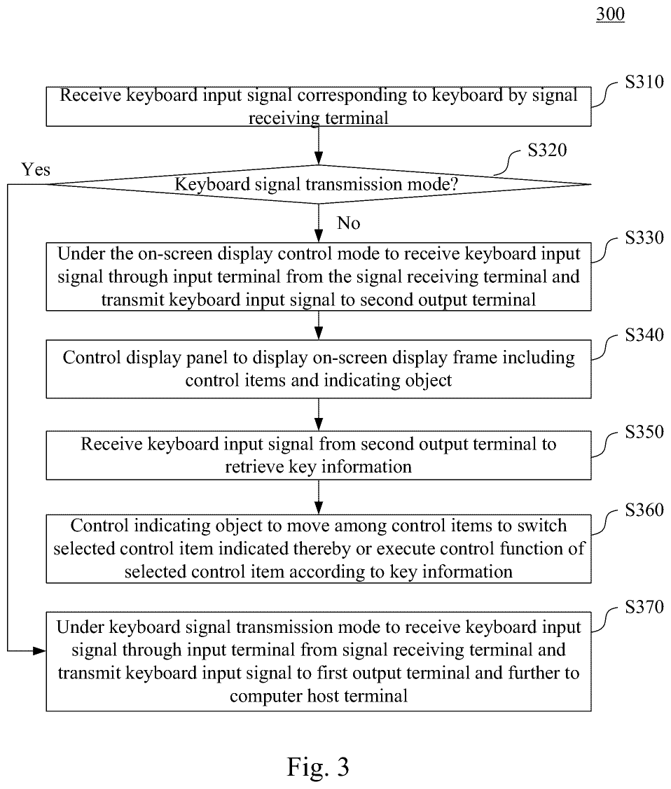

Reference is now made to FIG. 3. FIG. 3 illustrates a flow chart of an on-screen display control method 300 according to an embodiment of the present invention.

Besides the apparatus described above, the present invention further discloses the on-screen display control method 300 that can be used in such as, but not limited to the display apparatus 100 illustrated in FIG. 1. An embodiment of the on-screen display control method 300 is illustrated in FIG. 3 and includes the steps outlined below.

In step S310, the keyboard input signal KIS corresponding to the keyboard 150 is received by the signal receiving terminal 110.

In step S320, whether the signal transmission circuit 120 is under the keyboard signal transmission mode is determined.

In step S330, when the signal transmission circuit 120 is not under the keyboard signal transmission mode, the signal transmission circuit 120 is determined to be under the on-screen display control mode such that the keyboard input signal KIS is received through the input terminal IN from the signal receiving terminal 110 and the keyboard input signal KIS is transmitted to the second output terminal O2 by the signal transmission circuit 120.

In step S340, the display panel 130 is controlled to display the on-screen display frame 200 including the control items (e.g., the control items 210A˜210F) and the indicating object 220 under the on-screen display control mode, wherein one of the control items indicated by the indicating object 220 is selected to be a selected control item.

In step S350, the keyboard input signal KIS is received from the second output terminal O2 to retrieve the key information of the keyboard input signal KIS by the display control circuit 140.

In step S360, the indicating object 220 is controlled to move among the control items to switch the selected control item indicated thereby or execute the control function of the selected control item according to the key information by the display control circuit 140.

In step S370, when the signal transmission circuit 120 is under the keyboard signal transmission mode, the keyboard input signal KIS is received through the input terminal IN from the signal receiving terminal 110 and is transmitted to the first output terminal O1 and further to the computer host terminal 160.

It is appreciated that the embodiments described above are merely an example. In other embodiments, it is appreciated that many modifications and changes may be made by those of ordinary skill in the art without departing, from the spirit of the invention.

In summary, the display apparatus having an on-screen display control mechanism and the on-screen display control method of the same dispose a signal transmission circuit such that a keyboard input signal not only can be transmitted to a computer host terminal, but also to be used to intuitively adjust the on-screen display without the need to identify the location information.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A display apparatus having an on-screen display control mechanism, comprising:
a signal receiving terminal configured to receive a keyboard input signal corresponding to a keyboard;
a signal transmission circuit configured to receive the keyboard input signal through an input terminal from the signal receiving terminal, transmit the keyboard input signal to a first output terminal under a keyboard signal transmission mode and transmit the keyboard input signal to a second output terminal under an on-screen display control mode;
a display panel; and
a display control circuit electrically coupled to the signal transmission circuit and the display panel and configured to:
control the display panel to display an on-screen display frame comprising a plurality of control items and an indicating object under the on-screen display control mode, wherein one of the control items indicated by the indicating object is selected to be a selected control item;
receive the keyboard input signal from the second output terminal to retrieve key information of the keyboard input signal; and
control the indicating object to move among the control items to switch the selected control item indicated thereby or execute a control function of the selected control item according to the key information.

2. The display apparatus of claim 1, wherein the display control circuit identify the key information to be direction information or operation information according to an internal firmware, so as to move the indicating object among the control items to switch the selected control item indicated thereby when the key information is identified to be the direction information and execute the control function of the selected control item when the key information is identified to be the operation information.

3. The display apparatus of claim 1, wherein the keyboard input signal is generated by a plurality of specific keypads or a plurality of non-specific keypads of the keyboard, in which the key information of the specific keypads is configured to control the indicating object or execute the control function, and the key information of the non-specific keypads is not configured to control the indicating object or execute the control function; and
the signal transmission circuit is further configured to transmit the keyboard input signal generated according to the non-specific keypads to the first output terminal under both of the keyboard signal transmission mode and the on-screen display control mode.

4. The display apparatus of claim 3, wherein the signal transmission circuit is further configured to also transmit the keyboard input signal to the second output terminal under the keyboard signal transmission mode such that the display control circuit control the signal transmission circuit, according to a composite keypad signal formed by a multiple of the keyboard input signals generated simultaneously by the keyboard, to switch to be operated between the keyboard signal transmission mode and the on-screen display control mode; and
the signal transmission circuit stops to transmit the keyboard input signal generated by the specific keypads to the first output terminal under the on-screen display control mode.

5. The display apparatus of claim 1, wherein the signal transmission circuit switches to be operated between the keyboard signal transmission mode and the on-screen display control mode according to a composite keypad signal formed by a multiple of the keyboard input signals generated simultaneously by the keyboard.

6. The display apparatus of claim 1, wherein the first output terminal is electrically coupled to a computer host terminal, the signal transmission circuit is configured to transmit the keyboard input signal through the first output terminal to the computer host terminal under the keyboard signal transmission mode.

7. The display apparatus of claim 1, wherein the keyboard input signal includes human interface device (HID) descriptor information, the display control circuit is configured to retrieve the key information from the human interface device descriptor information.

8. The display apparatus of claim 7, wherein the signal transmission circuit is configured to perform format conversion on the human interface device descriptor information such that the display control circuit retrieves the key information from the format-converted human interface device descriptor information.

9. The display apparatus of claim 1, wherein the signal receiving terminal is a universal serial bus (USB) connection interface to be electrically coupled to the keyboard, and receive the keyboard input signal from the keyboard.

10. The display apparatus of claim 1, wherein the control function comprises entering a next layer menu to allow the indicating object indicating one of the control items comprised by the next layer menu, exiting to a pervious layer menu to allow the indicating object indicating one of the control items comprised by the pervious layer menu, or adjusting a display parameter of the display panel that the selected control item corresponds to.

11. An on-screen display control method used in a display apparatus, comprising:
receiving a keyboard input signal corresponding to a keyboard by a signal receiving terminal;
receiving the keyboard input signal through an input terminal from the signal receiving terminal, transmitting the keyboard input signal to a first output terminal under a keyboard signal transmission mode and transmitting the keyboard input signal to a second output terminal under an on-screen display control mode by a signal transmission circuit;
controlling the display panel to display an on-screen display frame comprising a plurality of control items and an indicating object under the on-screen display control mode by a display control circuit, wherein one of the control items indicated by the indicating object is selected to be a selected control item;
receiving the keyboard input signal from the second output terminal to retrieve key information of the keyboard input signal by the display control circuit; and
controlling the indicating object to move among the control items to switch the selected control item indicated thereby or execute a control function of the selected control item according to the key information by the display control circuit.

12. The on-screen display control method of claim 11, further comprising:
identifying the key information to be direction information or operation information according to an internal firmware by the display control circuit, so as to move the indicating object among the control items to switch the selected control item indicated thereby when the key information is identified to be the direction information and execute the control function of the selected control item when the key information is identified to be the operation information.

13. The on-screen display control method of claim 11, wherein the keyboard input signal is generated by a plurality of specific keypads or a plurality of non-specific keypads of the keyboard, in which the key information of the specific keypads is configured to control the indicating object or execute the control function, and the key information of the non-specific keypads is not configured to control the indicating object or execute the control function, the on-screen display control method further comprises:
transmitting the keyboard input signal generated according to the non-specific keypads to the first output terminal under both of the keyboard signal transmission mode and the on-screen display control mode by the signal transmission circuit.

14. The on-screen display control method of claim 13, further comprising:
also transmitting the keyboard input signal to the second output terminal under the keyboard signal transmission mode by the signal transmission circuit such that the display control circuit control the signal transmission circuit, according to a composite keypad signal formed by a multiple of the keyboard input signals generated simultaneously by the keyboard, to switch to be operated between the keyboard signal transmission mode and the on-screen display control mode
stopping to transmit the keyboard input signal generated by the specific keypads to the first output terminal by the signal transmission circuit under the on-screen display control mode.

15. The on-screen display control method of claim 11, further comprising:
switching to be operated between the keyboard signal transmission mode and the on-screen display control mode by the signal transmission circuit according to a composite keypad signal formed by a multiple of the keyboard input signals generated simultaneously by the keyboard.

16. The on-screen display control method of claim 11, wherein the first output terminal is electrically coupled to a computer host terminal, the on-screen display control method further comprises:
transmitting the keyboard input signal through the first output terminal to the computer host terminal under the keyboard signal transmission mode by the signal transmission circuit.

17. The on-screen display control method of claim 11, wherein the keyboard input signal includes human interface device (HID) descriptor information, the on-screen display control method further comprises:
retrieving the key information from the human interface device descriptor information by the display control circuit.

18. The on-screen display control method of claim 17, further comprising:
performing format conversion on the human interface device descriptor information by the signal transmission circuit such that the display control circuit retrieves the key information from the format-converted human interface device descriptor information.

19. The on-screen display control method of claim 11, wherein the signal receiving terminal is a universal serial bus (USB) connection interface to be electrically coupled to the keyboard, and receive the keyboard input signal from the keyboard.

20. The on-screen display control method of claim 11, wherein the control function comprises entering a next layer menu to allow the indicating object indicating one of the control items comprised by the next layer menu, exiting to a pervious layer menu to allow the indicating object indicating one of the control items comprised by the pervious layer menu, or adjusting a display parameter of the display panel that the selected control item corresponds to.
